(19) United States
(12) Patent Application Publication
(10) Pub. No.: US 2023/0148387 A1
(43) Pub. Date: May 11, 2023

(54) SLIDE AND LOCK APPLIANCE HANDLE MOUNTING

(71) Applicant: Haier US Appliance Solutions, Inc., Wilmington, DE (US)

(72) Inventor: Caleb Farrel, Jeffersonville, IN (US)

(21) Appl. No.: 17/520,943

(22) Filed: Nov. 8, 2021

(51) Int. Cl. F24C 15/02; E05B 1/00; E05B 3/00

(52) U.S. Cl. CPC F24C 15/024; E05B 1/0015; E05B 3/00

(57) ABSTRACT

An appliance may include a cabinet defining an opening, a door attached to the cabinet that allows selective access to the opening, a handle attached to the door, and a handle endcap that may removably connect the handle to the door. The handle endcap may include a slide lock receiver frame and a slide lock base removably attached to the slide lock receiver frame. The slide lock receiver frame may include a locking tab wall and an outer case. The slide lock base may include a base body, a resilient locking tab and a tab protrusion. The resilient locking tab may be joined to the base body to selectively deflect in an inward direction, the tab protrusion extending in an outward direction to motivate the resilient locking tab inward in response to slidable movement of the tab protrusion along the locking tab wall.

### FIELD OF THE INVENTION

The present subject matter relates generally to appliances and more particularly to appliance handles.

### BACKGROUND OF THE INVENTION

Household appliances generally define one or more enclosures or cabinets for heating, cooling, washing, or drying; at least one control panel; and at least one door that allows a user to open and close the one or more enclosures or cabinets. Each door may have a handle to facilitate the user opening and closing the at least one door of the household appliance to place articles into the one or more enclosures or cabinets. The doors are sometimes made of multiple parts to better insulate the inner cavity to allow for proper temperature distribution, airflow, or waterproofing during use. A door may further include an outer panel and inner panel. The handle of the door may be mounted to an outer surface of the door, such as to the outer surface of a front panel, and often is configured as a vertical or lateral bar to allow a towel or other useful article to be stored thereon. An inner hinge assembly may allow the door to open and close.

Handles can generally be attached to the outer surface of the door by screws or other known fixtures or adhesives. Handles may be attached through a panel of the door, for example, attached by screwing a screw through the front panel of the door from an inner surface of the door through the front panel and attaching to the handle located on the outer surface of the door. The handle cannot be removed in this situation without taking the door apart to reach the screws internal to the door. Handles attached this way are not readily replaceable, which adds to repairs and limits design options.

Accordingly, a door handle that could be readily attached and detached from an outer surface of a door would be useful. Furthermore, a handle that could be readily switched out for a different handle due to a repair or design change would also be desirable.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, an appliance is provided. The appliance may have a transverse, lateral and vertical direction, the directions orthogonal to one another. The appliance may include a cabinet defining an opening, a door attached to the cabinet that allows selective access into the opening, a handle attached to the door, and a handle endcap connecting the handle to the door. The handle endcap may be configured to removably attach the handle to the door. The handle endcap may include a slide lock receiver frame and a slide lock base. The slide lock receiver frame may include a locking tab wall and an outer case. The slide lock base may be removably attached to the slide lock receiver frame. The slide lock base may include a base body, a resilient locking tab and a tab protrusion. The resilient locking tab may be joined to the base body to selectively deflect in an inward direction. The tab protrusion may extend in an outward direction opposite of the inward direction to motivate the resilient locking tab inward in response to slidable movement of the tab protrusion along the locking tab wall.

In another exemplary aspect of the present disclosure a handle for a household appliance is provided. The handle may define a lateral direction, a vertical direction and a transverse direction, each direction orthogonal to the other directions. The handle may include at least one handle endcap configured to connect the handle to a door. The handle endcap may be configured to removably attach the handle to the door. The handle endcap may include a slide lock receiver frame and a slide lock base. The slide lock receiver frame may include a locking tab wall and an outer case. The slide lock base may include a base body, a resilient locking tab, and a tab protrusion. The resilient locking tab may be joined to the base body to selectively deflect in an inward direction. The tab protrusion may extend in an outward direction opposite of the inward direction to motivate the resilient locking tab inward in response to slidable movement of the tab protrusion along the resilient locking tab wall.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which: [will finish when FIGS. return from drafter]

FIG. 1 provides a perspective view of an exemplary embodiment of an oven appliance of the present disclosure;

FIG. 2 provides a side, section view of the exemplary oven appliance of FIG. 1;

FIG. 3 provides a side perspective section view of an exemplary handle endcap and a portion of an exemplary handle of the present disclosure;

FIG. 4 provides a front elevation view of a portion of the exemplary handle of FIG. 3;

FIG. 5 provides a rear elevation view of the exemplary handle endcap of FIG. 3 in a locked position;

FIG. 6 provides a side perspective section view of the exemplary handle endcap and a portion of the exemplary handle of FIG. 3;

FIG. 7 provides a side perspective section view of the exemplary handle endcap and the portion of the exemplary handle of FIG. 3;

FIG. 8 provides a perspective view of an exemplary embodiment of the exemplary handle endcap of FIG. 3;

FIG. 9 provides a rear perspective section view of the exemplary handle endcap and portion of the exemplary handle of FIG. 3;

FIG. 10 provides a rear elevation view of the exemplary handle endcap of FIG. 3 in an open position;

FIG. 11 provides a rear elevation view of the exemplary handle endcap of FIG. 3 in a locked position;

FIG. 12 provides a rear elevation view of a pair of exemplary handle endcaps of the present disclosure;

FIG. 13 provides a rear elevation view of an alternate pair of exemplary handle endcaps of the present disclosure;

FIG. 14 provides a rear elevation view of an alternate pair of exemplary handle endcaps of the present disclosure;

FIG. 15 provides a perspective view of an exemplary slide lock base of the present disclosure;

FIG. 16 provides a side perspective section view of an exemplary handle endcap and a portion of an exemplary handle of the present disclosure; and

FIG. 17 provides a rear elevation view of the exemplary handle endcap of FIG. 16.

Use of the same of similar reference numerals in the figures denotes the same or similar features unless the context indicates otherwise.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components. Terms such as “left,” “right,” “front,” “back,” “top,” or “bottom” are used with reference to the perspective of a user accessing the oven appliance (e.g., when the door is in the closed position). For example, a user stands in front of the oven appliance to open a door and reaches into the internal chamber(s) to access items therein.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise, or counterclockwise, with the vertical direction V).

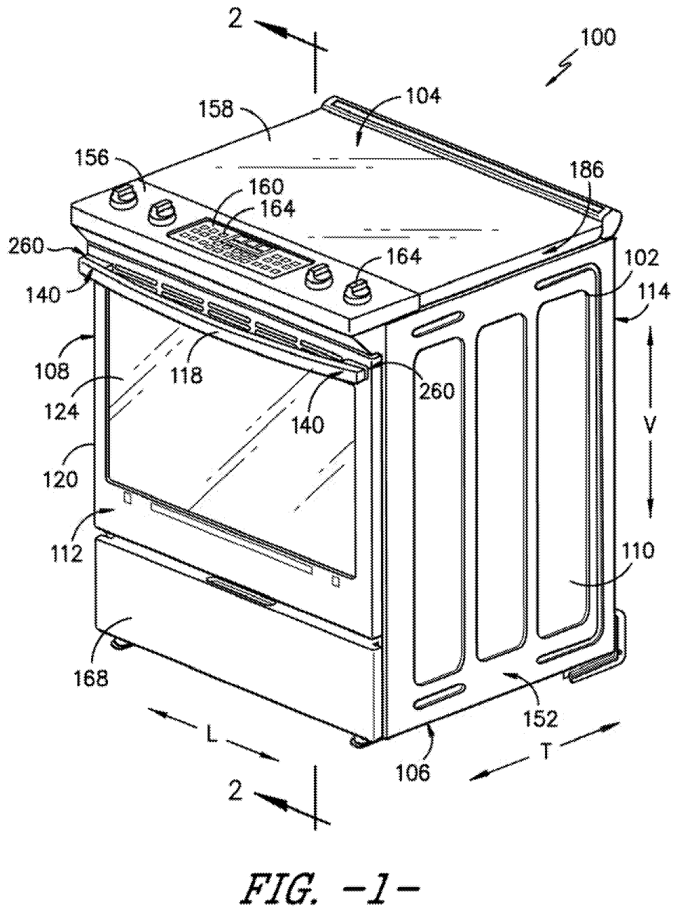

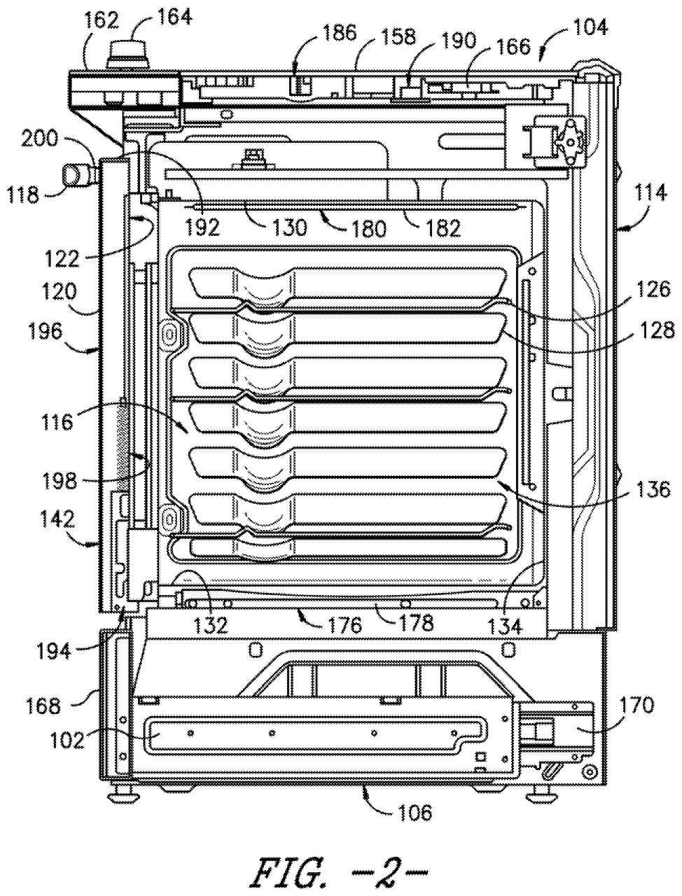

Referring now to the figures, an exemplary appliance will be described in accordance with exemplary aspects of the present subject matter. Specifically, FIG. 1 provides a perspective view of an exemplary oven appliance 100 and FIG. 2 provides a side cross-sectional view of oven appliance 100. As illustrated, oven appliance 100 generally defines a vertical direction V, a lateral direction L, and a transverse direction T, each of which is mutually perpendicular, such that an orthogonal coordinate system is generally defined.

According to exemplary embodiments, oven appliance 100 includes a cabinet 102 that is generally configured for containing and/or supporting various components of oven appliance 100 and which may also define one or more internal chambers or compartments of oven appliance 100. In this regard, as used herein, the terms “cabinet,” “housing,” and the like are generally intended to refer to an outer frame or support structure for oven appliance 100, e.g., including any suitable number, type, and configuration of support structures formed from any suitable materials, such as a system of elongated support members, a plurality of interconnected panels, or some combination thereof. It should be appreciated that cabinet 102 does not necessarily require an enclosure and may simply include open structure supporting various elements of oven appliance 100. By contrast, cabinet 102 may enclose some or all portions of an interior of cabinet 102. It should be appreciated that cabinet 102 may have any suitable size, shape, and configuration while remaining within the scope of the present subject matter.

As illustrated, cabinet 102 generally extends between a top 104 and a bottom 106 along the vertical direction V, between a first side 108 (e.g., the left side when viewed from the front as in FIG. 1) and a second side 110 (e.g., the right side when viewed from the front as in FIG. 1) along the lateral direction L, and between a front 112 and a rear 114 along the transverse direction T. In general, terms such as “left,” “right,” “front,” “rear,” “top,” or “bottom” are used with reference to the perspective of a user accessing oven appliance 100.

As will be understood by those skilled in the art, oven appliance 100 is provided by way of example only, and the present subject matter may be used in any suitable household appliance. The present subject matter may further be used with other household appliances such as microwave ovens, washing machine appliances, dryer appliances, dishwashing appliances, refrigerator appliances, etc. Oven appliance 100 will be described below, with the understanding that other embodiments may include or be provided as another suitable household appliance (e.g., defining an internal chamber).

Oven appliance 100 includes an internal chamber 116 disposed or defined within cabinet 102. Internal chamber 116 is also referred to as internal chamber 116 as used herein and may be insulated. In some embodiments, internal chamber 116 is configured for the receipt of one or more items to be cooked, including food items. Cabinet 102 defines internal chamber 116 between a top wall 130 and a bottom wall 132. Oven appliance 100 includes a door 120 rotatably mounted to cabinet 102 (e.g., with a hinge). A handle 118 is mounted to door 120 and assists a user with opening and closing door 120 in order to access internal chamber 116. For example, a user can pull on handle 118 to open or close door 120 and access internal chamber 116 through a resultant opening. As would be understood, one or more internal heating elements (e.g., baking heating elements 178 or broiling heating elements 182) may be provided within internal chamber 116 to cook or otherwise heat items therein.

Oven appliance 100 can include a seal 122 (e.g., gasket) between door 120 and cabinet 102 that assists with maintaining heat and cooking fumes within internal chamber 116 when door 120 is closed as shown. Door 120 may include a window 124, constructed for example from multiple parallel glass panes to provide for viewing the contents of internal chamber 116 when door 120 is closed and assist with insulating internal chamber 116. A baking rack 126 may be positioned in internal chamber 116 for the receipt of food items or utensils containing food items. Baking rack 126 may be slidably received onto embossed ribs 128 or sliding rails such that baking rack 126 may be conveniently moved into and out of internal chamber 116 when door 120 is open.

Generally, various sidewalls define internal chamber 116. For example, internal chamber 116 includes a top wall 130 and a bottom wall 132 that are spaced apart along the vertical direction V. Left and right sidewalls extend between top wall 130 and bottom wall 132, and are spaced apart along the lateral direction L. A rear wall 134 may additionally extend between the top wall 130 and bottom wall 132 as well as between the left and right sidewalls, and is spaced apart from door 120 along the transverse direction T. In this manner, when door 120 is in the closed position, a cavity 136 (also referred to as “cooking cavity 136” herein) is defined by door 120 and top wall 130, bottom wall 132, sidewalls, rear wall 134 of internal chamber 116.

In some examples, the top 104 includes a front panel 156 or cooktop panel 158. Front panel 156 may be located transversely forward of cooktop panel 158. Front panel 156 may house a controller 162 or controls 164, as described in more detail below. Additionally or alternatively, the cooktop panel 158 may be proximal to a plurality of heating assemblies 166, as described in more detail below.

A lower heating assembly (e.g., bake heating assembly 176) may be positioned in oven appliance 100, and may include one or more heating elements (e.g., bake heating elements 178). Bake heating elements 178 may be disposed within internal chamber 116, such as adjacent bottom wall 132. In exemplary embodiments as illustrated, bake heating elements 178 are electric heating elements, as is generally understood. Alternatively, bake heating elements 178 may be gas burners or other suitable heating elements having other suitable heating sources. Bake heating elements 178 may generally be used to heat internal chamber 116 for both cooking and cleaning of oven appliance 100.

Additionally or alternatively, an upper heating assembly (e.g., broil heating assembly 180) may be positioned in oven appliance 100, and may include one or more upper heating elements (e.g., broil heating elements 182). Broil heating elements 182 may be disposed within internal chamber 116, such as adjacent top wall 130. In exemplary embodiments as illustrated, broil heating elements 182 are electric heating elements, as is generally understood. Alternatively, broil heating elements 182 may be gas burners or other suitable heating elements having other suitable heating sources. Broil heating elements 182 may additionally be used to heat internal chamber 116 for both cooking and cleaning of oven appliance 100.

In some embodiments, oven appliance 100 includes a cooktop 186 positioned at cooktop panel 158 of oven appliance 100. In such embodiments, cooktop panel 158 may be a generally planar member having an upward surface that is perpendicular to the vertical direction V. In particular, cooktop panel 158 may be formed from glass, glass ceramic, metal, or another suitable material. A plurality of heating assemblies (e.g., cooktop heating assemblies 166) may be mounted to or otherwise positioned on cooktop panel 158. In some embodiments, cooktop heating assemblies 166 are positioned above internal chamber 116 of cabinet 102 (i.e., higher relative to the vertical direction V). Optionally, cooktop heating assemblies 166 may extend between internal chamber 116 and cooktop panel 158, within an open region 190 that is defined between cooktop panel 158 and internal chamber 116. Cooking utensils, such as pots, pans, griddles, etc., may be placed on cooktop panel 158 and heated with heating assemblies 166 during operation of the cooktop 186. In FIGS. 1 and 2, cooktop heating assemblies 166 are shown as radiant heating elements mounted below cooktop panel 158. However, in alternative example embodiments, cooktop heating assemblies 166 may be any suitable heating assembly, such as gas burner elements, resistive heating elements, induction heating elements, or other suitable heating elements.

The door 120 is mounted on the cabinet 102 below cooktop panel 158 to selectively allow access to the internal chamber 116 in a closed position. As may be seen in FIG. 2, door 120 extends between a top lip 192 and a bottom lip 194 (e.g., along the vertical direction V when door 120 is in the closed position). Door 120 may further extend between a front surface 196 and a rear surface 198 (e.g., along the transverse direction T when the door 120 is in the closed position). As will be described in greater detail below, a handle 118 may be provided on the door 120 proximal to top lip 192.

In some embodiments, oven appliance 100 includes a drawer 168 movably mounted to cabinet 102. For instance, drawer 168 may be slidably mounted to cabinet 102 to selectively move forward/rearward along the transverse direction T. One or more slidable rails, bearings, or assemblies 170 may be installed or mounted between drawer 168 and cabinet 102 to facilitate movement of drawer 168 relative to cabinet 102, as would be understood. As shown, drawer 168 may be disposed generally below internal chamber 116. In particular, drawer 168 may be disposed below door 120. Generally, drawer 168 is disposed between first side 108 and second side 110 (e.g., along the lateral direction L). Optionally, drawer 168 may be disposed above bottom 106. Alternatively, drawer 168 may be disposed below bottom wall 132 (e.g., such that an open cavity or recess is defined between panels below bottom wall 132 to receive drawer 168).

Oven appliance 100 is further equipped with a controller 162 to regulate operation of the oven appliance 100. For example, controller 162 may regulate the operation of oven appliance 100, including activation of heating elements as well as heating assemblies 166 generally. Controller 162 may be in operable communication (e.g., via a suitable electronic wired connection) with the heating elements and other components of the oven appliance 100, as discussed herein. In general, controller 162 may be operable to configure the oven appliance 100 (and various components thereof) for cooking. Such configuration may be based on a plurality of cooking factors of a selected operating cycles, sensor feedback, etc.

By way of example, controller 162 may include one or more memory devices (e.g., non-transitive media) and one or more microprocessors, such as general or special purpose microprocessors operable to execute programming instructions or micro-control code associated with an operating cycle. The memory may represent random access memory such as DRAM or read only memory such as ROM or FLASH. In exemplary embodiments, the processor executes programming instructions stored in memory. The memory may be a separate component from the processor or may be included onboard within the processor.

Controller 162 may be positioned in a variety of locations throughout oven appliance 100. For instance, controller 162 may be located within a user interface panel (also referred to as control panel 160) of oven appliance 100, as shown in FIG. 2. In some such embodiments, input/output (“I/O”) signals may be routed between the control system and various operational components of oven appliance 100 along wiring harnesses that may be routed through cabinet 102. In some embodiments, controller 162 is in operable communication (e.g., electronic or wireless communication) with user interface panel and controls 164, through which a user may select various operational features and modes and monitor progress of oven appliance 100. In optional embodiments, user interface panel may represent a general purpose I/O (“GPIO”) device or functional block. In certain embodiments, user interface panel includes input components or controls 164, such as one or more of a variety of electrical, mechanical, or electro-mechanical input devices including rotary dials, push buttons, and touch pads. Additionally or alternatively, user interface panel may include a display component, such as a digital or analog display device designed to provide operational feedback to a user. User interface panel may be in operable communication with controller 162 via one or more signal lines or shared communication busses.

Furthermore, the user interface panel (e.g., control panel 160) is located within convenient reach of a user of appliance. User interface panel includes various input components, such as one or more of a variety of touch-type controls 164, electrical, mechanical, or electro-mechanical input devices including knobs, rotary dials, push buttons, and touch pads. The user interface panel may include a display component, such as a digital or analog display device, designed to provide operational feedback to a user.

Various appliance features of appliance may be activated/deactivated by a user manipulating the input components on user interface panel. Thus, for example, when appliance is a cooktop 186 or oven appliance 100, a user may manipulate knobs or buttons on user interface panel to activate and deactivate heating elements of the appliance. As another example, a user of appliance may set a timer on user interface panel.

Embodiments of the present disclosure may include at least one handle endcap, and each handle endcap may include a slide lock receiver frame with a locking tab wall and a slide lock base with a locking tab extending therefrom. When one of the slide lock receiver frame and the slide lock base is attached to the handle and the other is attached to the door, the handle may be removably attached to the door, the locking tab sliding past the locking tab wall, confining the slide lock base within the slide lock receiver frame and attaching the handle to the door. The locking tab can be raised to slide past the locking tab wall, separating the slide lock base and the slide lock receiver frame, and allowing the handle to slide off the door. Thus, embodiments of the present disclosure include a handle that may be readily removed from or attached to the door. Additionally, alternate handles may also be readily attached to the door.

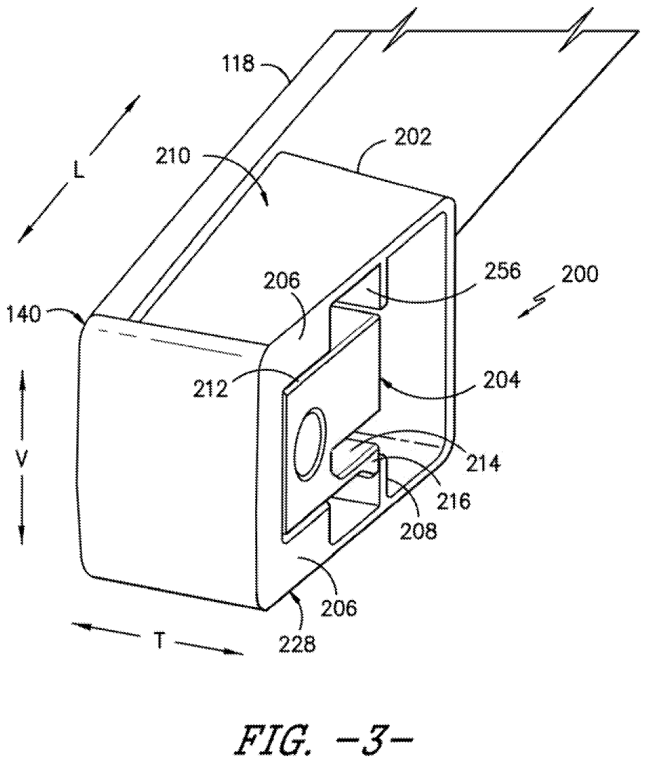

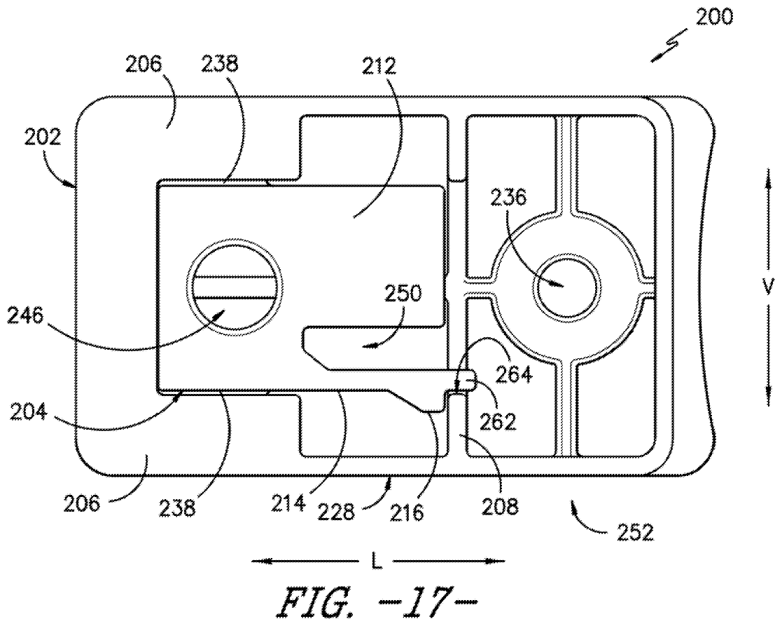

The remainder of the description describes features related to handle 118. As such, handle 118 may define a lateral direction L, a vertical direction V, and a transverse direction T, as shown in FIGS. 2 through 17. Each direction defined by handle 118 may be orthogonal to the other directions. To aid in clarity of description, the orientation of handle 118 in FIGS. 1 and 2 coordinates with the directions relative to appliance 100 in the remainder of the description (e.g., lateral direction L, vertical direction V and transverse direction T are the same L, T. or V direction whether defined in relation to appliance 100 or handle 118). Contrawise, in some embodiments, handle 118 may have directions that do not correspond with the directions defined by appliance 100. For example, if handle 118 is attached to door 120 at top lip 192, the directions defined in relation to handle 118, and as used in the remainder of the detailed description and in FIGS. 3 through 17 would not correspond to the directions defined by appliance 100 in FIGS. 1 and 2.

Turning generally to FIGS. 2 through 9, a handle endcap 200 is provided. Handle endcap 200 removably attaches handle 118 to door 120, as shown in FIG. 2. Handle endcap 200 includes a slide lock receiver frame 202 and a slide lock base 204. As shown, slide lock receiver frame 202 may be attached to handle 118 and slide lock base 204 may be attached to door 120. Additionally or alternatively, in embodiments of the present disclosure, slide lock receiver frame 202 and slide lock base 204 may be in an opposite configuration, with slide lock receiver frame 202 attached to door 120 and slide lock base 204 attached to handle 118. While the remainder of the description will describe the slide lock receiver frame 202 as attached to handle 118, it is understood that embodiments described herein may be in the aforementioned opposite configuration, with slide lock receiver frame 202 attached to door 120 and slide lock base 204 attached to handle 118, without departing from the scope of the disclosure. Furthermore, FIGS. 3 through 17 do not generally show slide lock base 204 attached to door 120, as such is omitted to allow for viewing of components and elements of handle endcap 200 with the understanding that slide lock base 204 may be attached to door 120.

As shown in FIG. 2, handle endcap 200 is located between handle 118 and door 120. More specifically, handle endcap 200 may be located behind handle 118 and in front of door 120. In some embodiments, handle endcap 200 may attach to door 120 at front surface 196. In additional or alternate embodiments, handle endcap 200 may attach to door 120 at top lip 192. During use, handle endcap 200 may be attached to both handle 118 and door 120.

Generally, handle endcap 200 includes slide lock receiver frame 202, shown as attached to handle 118 in FIG. 3, and slide lock base 204, shown as removeable from slide lock receiver frame 202 in FIG. 3. Handle endcap 200 may connect handle 118 to door 120. In some embodiments, handle endcap 200 may be configured to removably attach handle 118 to door 120. Handle endcap 200 may also include a set of fasteners (not shown) provided to attach handle endcap 200 to door 120 and to handle 118. The set of fasteners may include screws, glue, or equivalent fasteners, as known in the art.

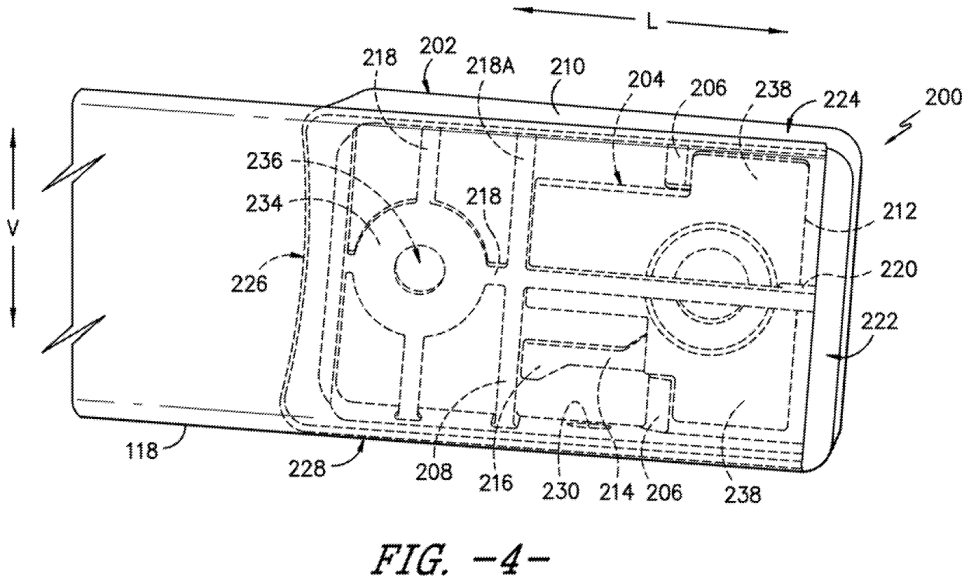

As shown in FIGS. 3 and 4, slide lock receiver frame 202 may be located forward of slide lock base 204 and beneath handle 118. In some embodiments, slide lock receiver frame 202 may be located at a lateral end 140 of handle 118. In certain embodiments, slide lock receiver frame 202 includes an outer case 210 and a locking tab wall 208 attached and extending internal to outer case 210. In certain embodiments, slide lock receiver frame 202 further includes at least one inner cross beam 218 and a central inner cross beam 220. Additionally or alternatively, slide lock receiver frame 202 may include a set of wings 206. When assembled, slide lock receiver frame 202 may cover slide lock base 204.

Generally, slide lock base 204 may include a base body 212, a resilient locking tab 214 extending from base body 212. In some embodiments, slide lock base 204 may further include a tab protrusion 216. Tab protrusion 216 may extend from resilient locking tab 214. In certain embodiments, slide lock base 204 may include a set of blades 238 extending on either side of base body 212. In additional or alternate embodiments, slide lock base 204 defines a base tab channel 250 running along a length of base body 212 between base body 212 and resilient locking tab 214. During use, slide lock base 204 may move between a locked position 252 and an unlocked position 254 within slide lock receiver frame 202.

Returning to slide lock receiver frame 202, locking tab wall 208 is generally located within outer case 210. As shown in FIG. 3, locking tab wall 208 may be orthogonal to a side wall 228, extending inward and upward from side wall 228. In some embodiments, locking tab wall 208 may further extend transversely across a majority a transverse length of side wall 228. In certain embodiments, locking tab wall 208 extends transversely across an entire transverse length of side wall 228. Additionally or alternatively, locking tab wall 208 may extends vertically to a height less than a vertical height of resilient locking tab 214, that is also greater than a lowest position of a tab protrusion 216 that extends from resilient locking tab 214 (e.g., when handle endcap 200 is in locked position 252). During use, locking tab wall 208 may prevent movement of slide lock base 204 when slide lock base 204 is in locked position 252, with tab protrusion 216 abutting locking tab wall 208. In some embodiments, locking tab wall 208 may aid in creating a friction fit between slide lock base 204 and slide lock receiver frame 202.

As shown in FIGS. 3, 4 and 5, outer case 210 may form an outside shell of slide lock receiver frame 202. Outer case 210 may attach to handle 118. Contrawise, in some embodiments, outer case 210 may attach to door 120. Outer case 210 may include a set of side walls 222, 224, 226, 228. Outer case 210 may define a void 230 along one wall of the set of side walls (e.g., side wall 228). In some embodiments, void 230 allows a pin 232 to enter into outer case 210 to unlock slide lock base 204 from slide lock receiver frame 202. In some embodiments, outer case 210 is attached to a set of wings 206. Wings 206 may be orthogonal to set of side walls 222, 224, 226, 228. During use, outer case 210 may be sized to friction fit slide lock base 204, when slide lock base 204 is in locked position 252.

Turning to FIGS. 4, 5, and 6, set of side walls 222, 224, 226, and 228 may form an outer perimeter of slide lock receiver frame 202. As shown, side walls 222 and 226 may be parallel to one another, and perpendicular to side walls 224, 228. In turn, side walls 224 and 228 may be parallel to one another and perpendicular to side walls 222 and 226. In some embodiments, side wall 228 may define void 230, aligning void 230 vertically with locked position 252 of resilient locking tab 214. In certain embodiments, base body 212 abuts at least one side wall (e.g., side wall 222) when base body 212 is in locked position 252, forming a friction fit between the at least one side wall (e.g., side wall 222) and locking tab wall 208. In additional or alternate embodiments, base body 212 in locked position 252 abuts side walls 222, 224, or 228, forming a friction fit between side walls 222, 224 or 228 and locking tab wall 208 in locked position 252.

Additionally or alternatively, inner cross beams 218 may extend within slide lock receiver frame 202. As shown, inner cross beams 218 may extend between side walls 222, 224, 226, 228 of outer case 210. In some embodiments, inner cross beams 218 may extend vertically in between opposing side walls 224, 228 or extend longitudinally between opposing side walls 222, 226. When assembled, inner cross beams 218 may be forward of set of wings 206 or of slide lock base 204. Inner cross beams 218 may include a fastener support 234. Inner cross beams 218 may be located transversely forward of set of wings 206 such that a transverse width of slide lock base 204 may be confined transversely forward of set of wings 206 and transversely back from inner cross beams 218.

In some embodiments, slide lock receiver frame 202 may include a stabilizing wall 256. Stabilizing wall 256 may be located vertically above locking tab wall 208. Stabilizing wall 256 may be located similar to locking tab wall 208, extending internally along a transverse length of outer case 210. As shown in FIGS. 3 and 6, stabilizing wall 256 may be longitudinally aligned with locking tab wall 208. Stabilizing wall 256 may extend downward into slide lock receiver frame 202 to confine or align slide lock base 204 in slide lock receiver frame 202.

Fastener support 236 may define fastening opening 236, allowing a fastener (not pictured) to attach slide lock receiver frame 202 to one of handle 118 and door 120 by placing the fastener through a fastening opening 236 and into either handle 118 or door 120. Fastener support 236 may provide support to the connection between slide lock receiver frame 202, the fastener (not pictured) and one of handle 118 and door 120. For example, the fastener may be inserted transversely through fastener opening 236 and into handle 118, attaching slide lock receiver frame 202 to handle 118.

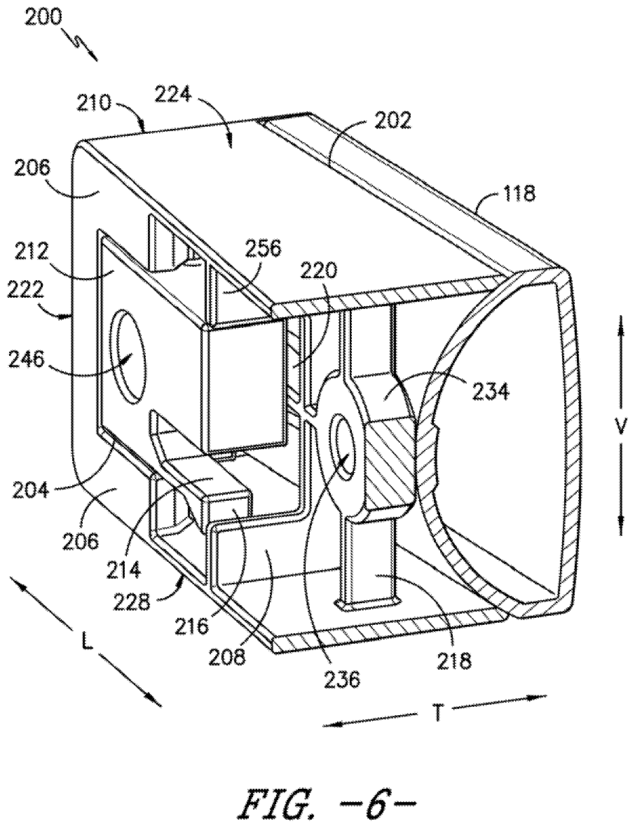

Additionally or alternatively, central inner cross beam 220 may extend within slide lock receiver frame 202. In some embodiments, central inner cross beam 220 extends between side wall 226 and side wall 222, extending longitudinally between opposing side walls. In some embodiments, central inner cross beam 220 extends between a vertical inner cross beam 218A and side wall 222. In certain embodiments, and as shown in FIG. 4, central inner cross beam 220 extends lengthwise from side wall 222, extending transversely backward at a distance greater than the transverse distance of inner cross beams 218. In some embodiments, central inner cross beam 220 is attached to at least one of inner cross beams 218. According to the arrangement, central inner cross beam 220 may extend transversely rearward and may removably attach to slide lock base 204 at cross beam channel 242 along base body 212. In some embodiments, central inner cross beam 220 may aid in aligning or guiding slide lock base 204 into locked position 252. As shown in FIG. 7, central inner cross beam 220 may be placed in cross beam channel 242 when slide lock base 204 is in locked position 252. In some embodiments, central inner cross beam 220 may aid in confining slide lock base 204 in locked position 252 with locking tab wall 208.

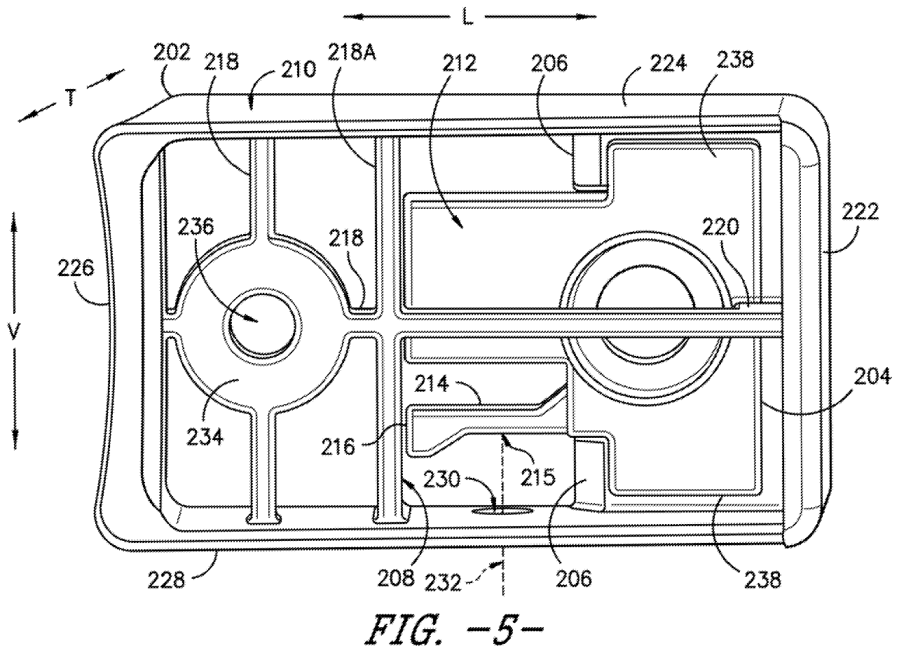

Turning to FIGS. 5, 6, and 7, slide lock receiver frame 202 may include set of wings 206. Generally, set of wings 206 may extend from slide lock receiver frame 202. In some embodiments, set of wings 206 may further be offset from resilient locking tab wall 208. As shown, set of wings 206 may be offset from resilient locking tab wall 208 in the lateral direction. In some embodiments, set of wings 206 may extend from opposing side walls in set of side walls 222, 224, 226, 228, such as at least one separate or discrete wing 206 extending from each side wall 224 and side wall 228, as shown in FIGS. 5 and 6. Thus, one (e.g., first) wing 206 may extend from side wall 224 while another (e.g., second) wing 206 extends from side wall 228. Additionally or alternatively, set of wings 206 may be each attached to opposing internal sides of outer case 210, each wing 206 extending towards other wing 206 in set of wings 206. In some embodiments, set of wings 206 extends vertically towards central inner cross beam 220, attaching at a transverse rearward position on outer case 210 (e.g., at a transverse rearward position of side walls 224 and 228).

Set of wings 206 may aid in forming a friction fit between slide lock base 204 and slide lock receiver frame 202. In some embodiments, set of wings 206 aligns transversely behind a set of blades 238 on slide lock base 204, overlapping each wing 206 with a corresponding blade 238. When assembled in locked position 252, set of wings 206 may be transversely behind blades 238, overlapping blades 238 of slide lock base 204. As would be understood, set of wings 206 may confine set of blades 238 in slide lock receiver frame 202 when in locked position 252.

In some embodiments, slide lock receiver frame 202 further defines void 230. In additional or alternative embodiments, void 230 is aligned (e.g., vertically aligned) with a portion 215 of resilient locking tab 214 along a length of slide lock receiver frame 202. The alignment of void 230 may allow a pin 232 to be inserted past side wall 228 and removably attach to resilient locking tab 214.

As would be understood, handle endcap 200 may further comprise pin 232, as shown in FIG. 5. Pin 232 may generally be an elongated member with a diameter smaller than void 230 to allow pin 232 to be actuated through void 230. Pin 232 may be aligned with portion 215 of resilient locking tab 214 along a length of slide lock receiver frame 202. During use, pin 232 may selectively lift tab protrusion 216 above locking tab wall 208. For example, pin 232 may be raised vertically, raising resilient locking tab 214, which may raise tab protrusion 216 vertically above locking tab wall 208. In some embodiments, pin 232 is actuated through void 230. Pin 232 may further be orthogonal to resilient locking tab 214. In certain embodiments, pin 232 is attached to slide lock receiver frame 202 at void 230. In additional or alternative embodiments, pin 232 is removable from handle endcap 200.

Turning to FIGS. 7, 8, and 9, slide lock base 204 is removably attached to slide lock receiver frame 202. In some embodiments, slide lock base 204 is further located behind and internal to slide lock receiver frame 202 when in locked position 252. In certain embodiments, slide lock base 204 is attached to an outer surface 142 of door 120. In additional or alternate embodiments, slide lock base 204 is attached to a lateral end of outer surface 142. When assembled, slide lock base 204 is confined by slide lock receiver frame 202, with outer case 210 generally confining slide lock base 204. In some embodiments, slide lock receiver frame 202 confines slide lock base 204 within outer case 210. Side walls 222, 224, 226, 228 may further confine slide lock base 204. Optionally, stabilizing wall 256 may confine slide lock base 204 with locking tab wall 208 vertically. In some embodiments, slide lock base 204 may be moveable between unlocked position 254 and locked position 252 in a lateral direction, between opposing side walls 222, 226.

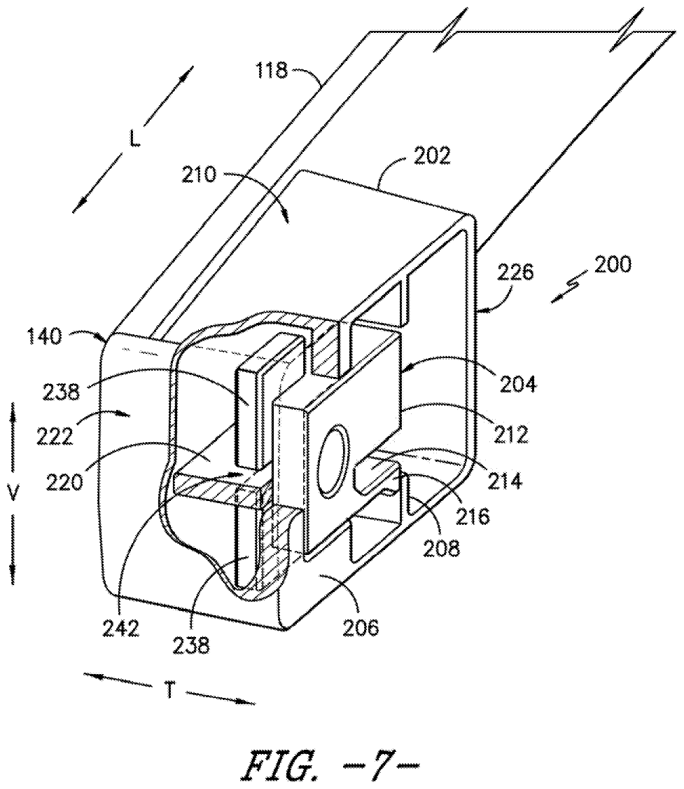

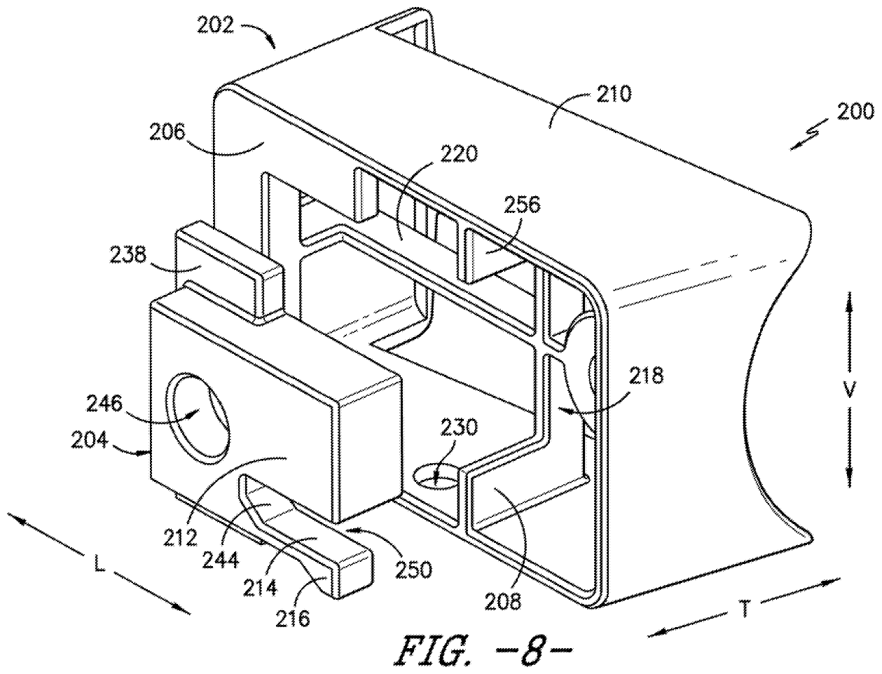

Additionally or alternatively to parts described above, slide lock base 204 may include cross beam channel 242, which may be slidably attached to central inner cross beam 220. In some embodiments, slide lock base 204 may include a locking tab support 244, as shown in FIGS. 8, 9, configured to strengthen the attachment of resilient locking tab 214 to base body 212. The parts of slide lock base 204 will now be described in greater detail.

In some embodiments, base body 212 is located vertically above and laterally next to resilient locking tab 214, resilient locking tab 214 extending from a lower extended portion of base body 212. Base body 212 and resilient locking tab 214 may define base tab channel 250, base tab channel 250 extending longitudinally between base body 212 and resilient locking tab 214, with resilient locking tab 214 vertically below base tab channel 250.

As previously described, slide lock base 204 further includes set of blades 238. Generally, blades 238 extend from base body 212. In some embodiments, blades 238 are offset (e.g., offset laterally) from resilient locking tab 214. Furthermore, blades 238 may be slidably aligned forward to set of wings 206. For example, in locked position, and as shown in FIG. 7, blades 238 are transversely in front of wings 206. Wings 206 combined with outer case 210 may confine blades 238 while locking tab wall 208 confines resilient locking tab 214. The interlocking of blades 238 with wings 206 may confine or help to confine slide lock base 204, attaching or aiding in attaching handle 118 to door 120. In some embodiments, blades 238 are attached to base body 212 on a surface of base body 212 orthogonal to the direction resilient locking tab 214 extends from base body 212. Blades 238 may be each be located on opposing positions of said surface of base body 212. For example, as shown in FIG. 7, blades 238 are attached at opposing vertical ends of a transversely forward surface of base body 212 while resilient locking tab 214 extends laterally from base body 212. In some embodiments, cross beam channel 242 may extend between blades 238. In certain embodiments, blades 238 may define cross beam channel 242, with central inner cross beam 220 filling cross beam channel 242 between blades 238 on base body 212.

Base fastener opening 246 may be defined by base body 212. Base fastener opening 246, as shown in FIG. 8, may extend through base body 212 (e.g., extending through transverse length of base body 212). A fastener (not pictured) may attach slide lock base 204 to one of handle 118 and door 120 by placing the fastener through base fastener opening 246 and into either handle 118 or door 120. For example, the fastener (not pictured) may be inserted transversely through base fastener opening 246 and into door 120, attaching slide lock base 204 to door 120 (e.g., at outer surface 142 of door 120). In some embodiments, two fasteners may be included in handle endcap 200, a first fastener extending through fastener opening 236 and the second fastener extending through base fastener opening 246.

Resilient locking tab 214 may be generally joined to base body 212. In some embodiments, resilient locking tab 214 extends along a length of base body 212. For example, as shown in FIG. 8, resilient locking tab 214 extends along a lower lateral length of base body 212. Resilient locking tab 214 may be moveable in a vertical direction, toward base tab channel 250, and may selectively deflect in an inward direction toward base tab channel 250. Resilient locking tab support 244 may strengthen the attachment of resilient locking tab 214 to base body 212. During use, resilient locking tab support 244 may strengthen attachment of locking tab 214 to base body 212 as locking tab 214 deflects during movement into locked position 252.

Tab protrusion 216 may extend from a lengthwise end of resilient locking tab 214. In some embodiments, tab protrusion 216 is perpendicular to the length of base body 212 (e.g., the lateral length of base body 212). In certain embodiments, tab protrusion 216 is further perpendicular to the length of resilient locking tab 214 (e.g., the lateral length of base body 212). For example, tab protrusion 216 extends vertically below resilient locking tab 214 at lengthwise end 248 of locking tab 214, as shown in FIG. 9.

As previously described, tab protrusion 216 abuts resilient locking tab wall 208. In some embodiments, a friction fit is formed by the aforementioned abutment, between slide lock base 204 and outer case 210. Such friction fit may be formed when slide lock base 204 is in locked position 252. Tab protrusion 216 may further be deflectable in an inward direction (e.g., vertically upward), towards base body 212 to motivate resilient locking tab 214 inward and over locking tab wall 208 during movement between unlocked position 254 and locked position 252.

In some embodiments, a taper 240 aids in movement of resilient locking tab 214. Taper 240 may be attached to both tab protrusion 216 and resilient locking tab 214. In some embodiments, taper 240 extends behind tab protrusion 216, taper 240 narrowing from tab protrusion 216 to a lower side 241 of resilient locking tab 214. For example, in FIG. 9, taper 240 is laterally behind tab protrusion and vertically below resilient locking tab 214. Taper 240 may be on an opposite side of tab protrusion 216 from lengthwise end 248 of resilient locking tab 214. During use, taper 240 may aid upward deflection of resilient locking tab 214 over locking tab wall 208, guiding locking tab 214 upward smoothly as slide lock base 204 moves into locked position 252.

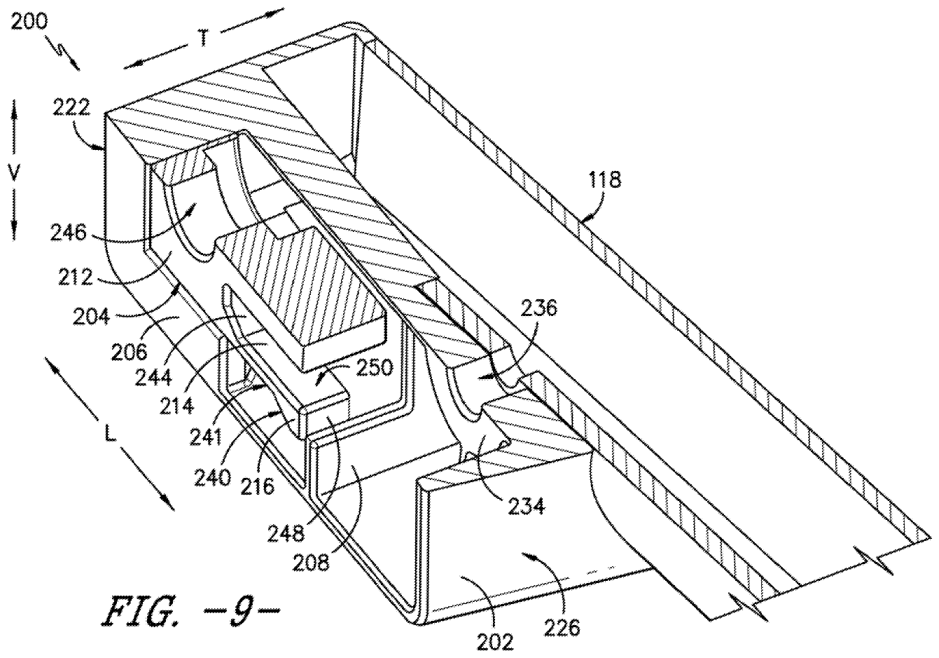

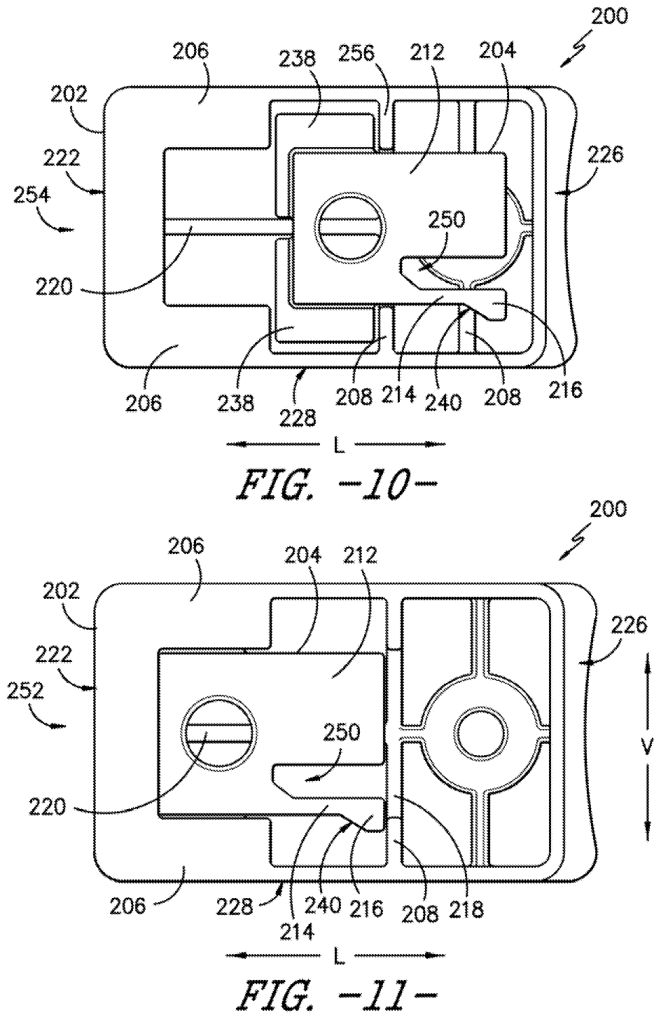

Turning to FIGS. 10 and 11, FIG. 10 depicts handle endcap 200 in unlocked position 254 and FIG. 11 depicts handle endcap 200 in locked position 252. During assembly, slide lock receiver frame 202 aligns with slide lock base 204 in unlocked position 254 as shown in FIG. 10. Slide lock base 204 may be vertically aligned with base body 212 above locking tab wall 208 when in unlocked position 254. In some embodiments, base body 212 may further be aligned below stabilizing wall 256 in unlocked position 254. In certain embodiments, central inner cross beam 220 may be aligned into cross beam channel 242 in unlocked position 254. Slide lock receiver frame 202 may confine slide lock base 204 within outer case in unlocked position 254.

To lock handle endcap 200, slide lock base 204 slides in relation to slide lock receiver frame 202 (e.g., slide lock base 204 slides in lateral direction L toward side wall 222). As slide lock base 204 moves across locking tab wall 208, resilient locking tab 214 engages locking tab wall 208, sliding across a top surface of locking tab wall 208. In some embodiments, taper 240 on resilient locking tab 214 engages with locking tab wall 208 as slide lock base 204 moves laterally within slide lock receiver frame 202. As taper 240 moves across locking tab wall 208, resilient locking tab 214 may be vertically raised toward base tab channel 250. In some embodiments, resilient locking tab 214 joined to base body 212 selectively deflects in an inward direction. Tab protrusion 216 may extend in an outward direction opposite the inward direction to motivate resilient locking tab inward in response to slidable movement of tab protrusion 216 along locking tab wall 208. When tab protrusion 216 reaches locking tab wall 208, slide lock base 204 may continue moving laterally toward locked position 252, and resilient locking tab 214 may have reached a maximum deflection, moving laterally and not vertically as tab protrusion 216 moves laterally across locking tab wall 208. When slide lock base 204 reaches locked position 252, tab protrusion 216 clears locking tab wall 208, and resilient locking tab 214 deflects back into an elastic resting position behind locking tab wall 208.

Generally, in locked position 252, and as shown in FIG. 11, slide lock base 204 is transversely behind slide lock receiver frame 202. In some embodiments, locked position 252 includes aligning blades 238 with wings 206. Locked position 252 may include aligning central inner cross beam 220 into cross beam channel 242. In embodiments with wings 206, slide lock base 204 is transversely behind slide lock receiver frame 202 save set of wings 206 of slide lock receiver frame 202. Slide lock base 204 may be confined by slide lock receiver frame 202 in locked position 252.

When tab protrusion 216 is raised above locking tab wall 208 (e.g., by pin 232 entering through void 230), slide lock base 204 may be moved from locked position 252 into unlocked position 254, and may separate from slide lock receiver frame 202.

Turning to FIGS. 12, 13, and 14, handle 118 may include at least one handle endcap 200. In certain embodiments, the at least one handle endcap 200 includes a pair of handle endcaps 200A, 200B. Handle endcaps 200A, 200B may attach to opposing lateral ends 140 of handle 118 and to opposing lateral ends 260 (shown in FIG. 1) of door 120. In some embodiments, and as shown in FIG. 12, handle endcaps 200A and 200B may be the same, each handle endcap 200A, 200B including resilient locking tab 214, tab protrusion 216 and locking tab wall 208.

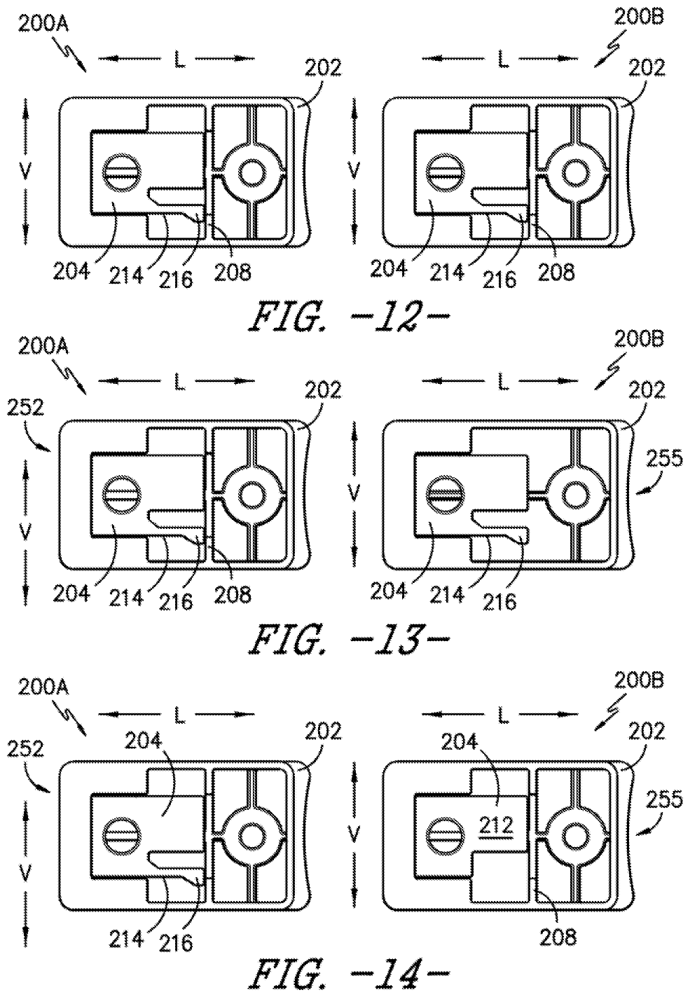

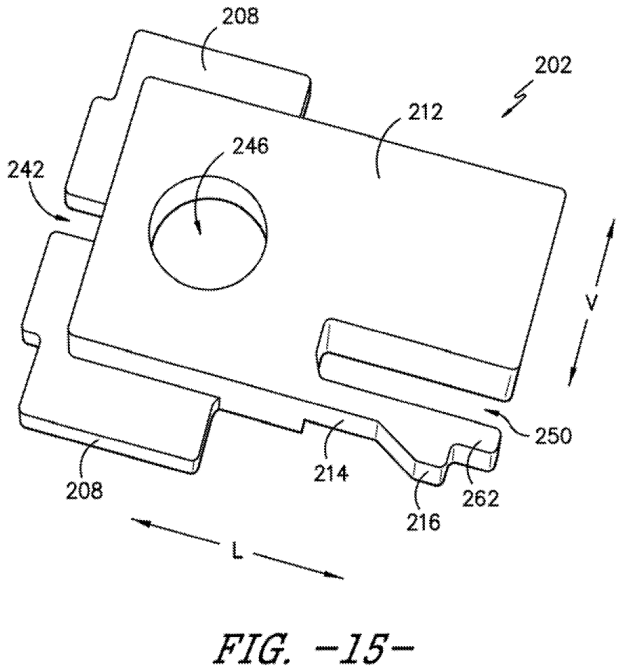

In alternate embodiments, and as shown in FIGS. 13, 14, each handle endcap 200A, may be different from handle endcap 200B. For example, only one of handle endcaps 200A, 200B may have locked position 252 and unlocked position 254, with the other of handle endcaps 200A, 200B only having an unlocked position 255. As shown in FIG. 13, one handle endcap (e.g., handle endcap 200B) may include resilient locking tab 214, and tab protrusion 216, but not include locking tab wall 208. The other handle endcap (e.g., handle endcap 200A) may include resilient locking tab 214, tab protrusion 216 and locking tab wall 208. Hence, as shown in FIG. 13, handle endcap 200B does not have locking position 252. A friction fit between slide lock receiver frame 202 attached to slide lock base 204 may attach handle 118 to door 120 at handle endcap 200B, with only a lock present at handle endcap 200A. Though handle endcaps 200A, 200B are shown in FIGS. 12, 13, 14 with handle endcap 200A on a left and handle endcap 200B on a right, handle endcaps 200A, 200B may be switched without departing from the scope of the embodiments disclosed herein.

Additionally or alternatively, as shown in FIG. 14, one handle endcap (e.g., handle endcap 200B) may include locking tab wall 208 but not include resilient locking tab 214 nor tab protrusion 216. The other handle endcap (e.g., handle endcap 200A) may include resilient locking tab 214, tab protrusion 216 and locking tab wall 208.

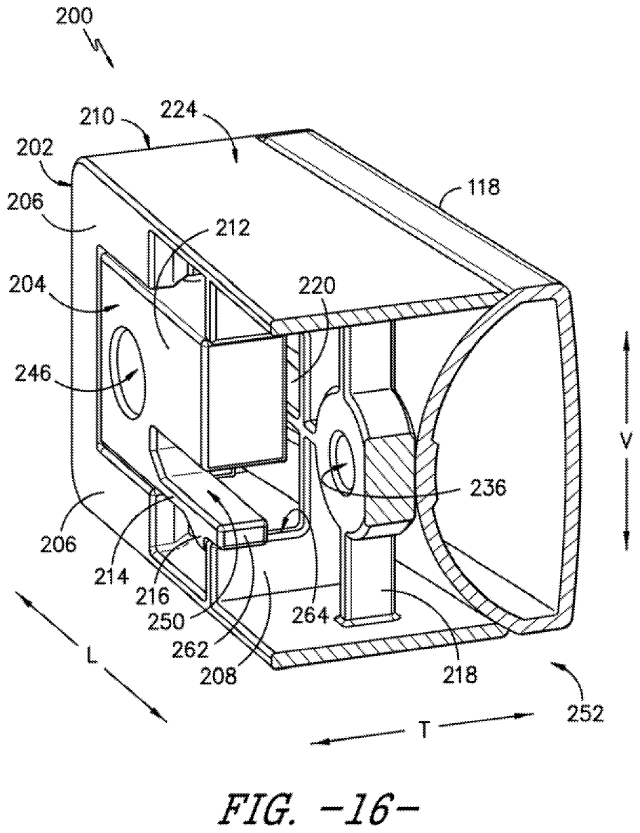

Turning to FIGS. 15, 16, and 17, in some alternate embodiments, slide lock base 204 may further include a lateral tab protrusion 262. Lateral tab protrusion 262 may extend laterally beyond a lateral position on resilient locking tab 214 where tab protrusion 216 extends below resilient locking tab 214. As shown, lateral tab protrusion 262 may rest on a top surface 264 of locking tab wall 208, with tab protrusion 216 still being behind locking tab wall 208 in locked position 252. In some such embodiments, locking tab 214, tab protrusion 216, and lateral tab protrusion 262 form a “T” shape at an endpoint of locking tab 214. In some embodiments, in locked position 252, lateral tab protrusion 262 and tab protrusion 216 are confined against locking tab wall 208 at a corner formed by lateral tab protrusion 262 meeting tab protrusion 216.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An appliance having a transverse, lateral and vertical direction, the directions orthogonal to one another, the appliance comprising:
a cabinet defining an opening;
a door attached to the cabinet that allows selective access into the opening;
a handle attached to the door; and
a handle endcap connecting the handle to the door, the handle endcap configured to removably attach the handle to the door, the handle endcap comprising:
a slide lock receiver frame comprising a locking tab wall and an outer case; and
a slide lock base removably attached to the slide lock receiver frame, the slide lock base comprising a base body, a resilient locking tab, and a tab protrusion, the resilient locking tab joined to the base body to selectively deflect in an inward direction, the tab protrusion extending in an outward direction opposite of the inward direction to motivate the resilient locking tab inward in response to slidable movement of the tab protrusion along the locking tab wall.

2. The appliance of claim 1, wherein the slide lock receiver frame confines the slide lock base within the outer case, and
wherein the tab protrusion abuts the resilient locking tab wall with a friction fit between the slide lock base and the outer case.

3. The appliance of claim 1, wherein the slide lock receiver frame further comprising a set of wings extending from the slide lock receiver frame and offset from the resilient locking tab wall.

4. The appliance of claim 3, the slide lock base further comprising a set of blades extending from the base body and offset from the resilient locking tab and slidably aligned forward to the set of wings.

5. The appliance of claim 1, wherein the resilient locking tab extends along a length of the base body, and
wherein the tab protrusion extends from a lengthwise end of the resilient locking tab perpendicular to the length of the base body.

6. The appliance of claim 5, wherein the tab protrusion comprises a taper extending behind the tab protrusion, the taper narrowing to a lower side of resilient locking tab.

7. The appliance of claim 1, wherein the slide lock receiver frame further defines a void, the void aligned with a portion of the resilient locking tab along a length of the slide lock receiver frame.

8. The appliance of claim 7, wherein the handle endcap further comprises a pin, the pin aligned with the portion of the resilient locking tab along a length of the slide lock receiver frame to selectively lift the tab protrusion above the resilient locking tab wall, the pin actuated through the void, the pin orthogonal to the resilient locking tab.

9. The appliance of claim 1, wherein the slide lock base is attached to the door and the slide lock receiver frame is attached to the handle.

10. The appliance of claim 1, wherein the slide lock base is attached to the handle and the slide lock receiver frame is attached to the door.

11. A handle for a household appliance, the handle defining a lateral direction, a vertical direction and a transverse direction, each direction orthogonal to the other directions, the handle comprising:
at least one handle endcap configured to connect the handle to a door, the handle endcap configured to removably attach the handle to the door, the handle endcap comprising:
a slide lock receiver frame comprising a locking tab wall and an outer case; and
a slide lock base removably attached to the slide lock receiver frame, the slide lock base comprising a base body, a resilient locking tab, and a tab protrusion, the resilient locking tab joined to the base body to selectively deflect in an inward direction, the tab protrusion extending in an outward direction opposite of the inward direction to motivate the resilient locking tab inward in response to slidable movement of the tab protrusion along the resilient locking tab wall

12. The handle of claim 11, wherein the slide lock receiver frame further comprising a set of wings extending from the slide lock receiver frame and offset from the resilient locking tab wall.

13. The handle of claim 12, the slide lock base further comprising a set of blades extending from the base body and offset from the resilient locking tab and slidably aligned forward to the set of wings.

14. The handle of claim 11, wherein the resilient locking tab extends along a length of the base body, and
wherein the tab protrusion extends from a lengthwise end of the resilient locking tab perpendicular to the length of the base body.

15. The handle of claim 14, wherein the tab protrusion comprises a taper extending behind the tab protrusion, the taper narrowing from the tab protrusion to a lower side of resilient locking tab.

16. The handle of claim 11, wherein the slide lock receiver frame further comprises a void, the void aligned with a portion of the resilient locking tab along a length of the slide lock receiver frame.

17. The handle of claim 16, wherein the handle endcap further comprises a pin, the pin aligned with the portion of the resilient locking tab along a length of the slide lock receiver frame to selectively lift the tab protrusion above the resilient locking tab wall, the pin actuated through the void, the pin orthogonal to the resilient locking tab.

18. The handle of claim 11, wherein the at least one handle endcap comprises a pair of handle endcaps.
